(19) United States
(12) Patent Application Publication
(10) Pub. No.: US 2010/0036715 A1
(43) Pub. Date: Feb. 11, 2010

(54) METHOD AND SYSTEM FOR ESTIMATING PRODUCTIVITY OF A TEAM

(76) Inventors: Harish Sathyan, Kollam (IN); Jithesh Sathyan, Kollam (IN)

Correspondence Address: MICHAEL BEST & FRIEDRICH LLP, 100 E WISCONSIN AVENUE, Suite 3300, MILWAUKEE, WI, 53202, US

(21) Appl. No.: 12/536,849

(22) Filed: Aug. 6, 2009

(30) Foreign Application Priority Data
Aug. 6, 2008 (IN) 1890/CHE/2008

(51) Int. Cl. G06Q 10/00

(52) U.S. Cl. 705/11

(57) ABSTRACT

The present invention provides a method, system and computer program product for estimating the productivity of a team for a project. The project includes various activities that are performed using an Extract, Transform and Load (ETL) tool. The method includes identifying the level of language of the ETL tool from a first predefined table, which represents the relationship between the level of language and the generation of language of the ETL tool. The method further includes assigning a rule number to the activities performed by the ETL tool for the project. Thereafter, the productivity of the team is calculated based on the level of language, the rule number of the activities, and the time taken by the team to complete the project.

### BACKGROUND

The present invention relates to the field of productivity estimation for project management. More specifically, the present invention relates to a method and system for estimating the productivity of a team working on a project being performed by using an Extract, Transform and Load (ETL) tool.

Productivity estimation is an integral part of project management in software organizations. The estimation of productivity facilitates and improves resource management, decision making, budget estimation, and so forth.

Currently, various techniques are available to estimate productivity. Some of these techniques include, but are not limited to, function point analysis technique, Lines of Code (LOC) technique, object points technique, use case technique, task-based estimation technique, and historical data based technique.

These techniques are used to estimate productivity for Information Technology (IT) projects and provide accurate results for projects performed using programming languages such as C++, Java, and so forth. However, one or more of the techniques above produce less accurate results when used to estimate productivity for projects performed using ETL tools.

One or more of these techniques use the Simple Medium Complex (SMC) model to estimate productivity. These techniques classify various tasks related to the project being performed into simple, medium or complex, based on the complexity level of the task. The estimation of productivity using the SMC model is based on experience and intuition. Further, the level of expertise of the team members is not considered while estimating productivity, which may produce inaccurate results. Typically, the estimate of productivity is expressed in terms of user-defined units. Therefore, the SMC model does not provide accurate results when used to estimate productivity for projects being performed using ETL tools.

There are some techniques provided in the art, which are available to estimate productivity for projects performed using ETL tools. Some of these techniques have one or more of the following limitations. One or more of these techniques rely on intuition and experience, which may not produce accurate results. Further, there is shortage of simple and standardized techniques to efficiently estimate productivity for projects using ETL tools. Moreover, these techniques do not use the level of language of the ETL tool to estimate productivity, which may also produce inaccurate results. These techniques do not provide an estimate of productivity in standard units. In addition, these techniques do not consider the level of expertise of the team members to estimate productivity.

In light of the above, there is a need for a method, system and computer program product for efficiently estimating productivity for projects using ETL tools. Further, the method should enable use of the level of language of the ETL tool to estimate productivity. Moreover, the method should enable use of the level of expertise of the team members to estimate productivity.

### SUMMARY

An object of the invention is to efficiently estimate productivity for Extract, Transform and Load (ETL) tools.

Another object of the invention is to use the level of language of the ETL tool to estimate productivity.

Yet another object of the invention is to use the level of expertise of the team members to estimate productivity.

To achieve the objectives mentioned above, the invention provides a method, system and computer program product for estimating the productivity of a team working on a project. Various activities are performed using an ETL tool for execution of the project. The method includes identifying the level of language of the ETL tool from a first predefined table that represents the relationship between the level of language and the generation of language of the ETL tool. The method further includes assigning a rule number to the activities performed by the ETL tool. Thereafter, the productivity of the team is calculated, based on the level of language, the rule number of the activities, and the time taken by the team to complete the project.

The method enables use of the level of language of the ETL tool to estimate productivity. Further, the level of language helps in efficient estimation of productivity.

### BRIEF DESCRIPTION OF THE DRAWINGS

Various embodiments of the invention will hereinafter be described in conjunction with the appended drawings, provided to illustrate, and not to limit, the invention, wherein like designations denote like elements, and in which:

FIG. 1 illustrates a flowchart of a method for estimating the productivity of a team, in accordance with an embodiment of the invention;

FIG. 2 illustrates a flowchart of a method for estimating the productivity of a team, in accordance with another embodiment of the invention;

FIG. 3 illustrates a section of a Caper Jones Language Table© used to estimate the productivity of a team, in accordance with an embodiment of the invention;

FIG. 4 illustrates a section of a Caper Jones language level relationship to productivity table© used to estimate the productivity of a team, in accordance with an embodiment of the invention; and

FIG. 5 is a block diagram of a system for estimating the productivity of a team, in accordance with an embodiment of the invention.

### DESCRIPTION OF VARIOUS EMBODIMENTS

The invention describes a method, system and computer program product for estimating the productivity of a team working on a project. Productivity provides a quantitative and qualitative value which indicates the efficiency of the team in the project. The team includes one or more members. The project includes one or more activities performed using an Extract, Transform and Load (ETL) tool. Examples of ETL tools include, but are not limited to, Ab Initio®, Oracle Warehouse Builder® (OWB), Business Objects Data Integrator and Services® (BODI), and Informatica®. Examples of the activities being performed using the ETL tool include, but are not limited to, reading from files, writing to files, reading from tables, writing to tables, use of transformations such as sort and join, use of aggregations such as roll up and record format changes, and creating user-defined functions.

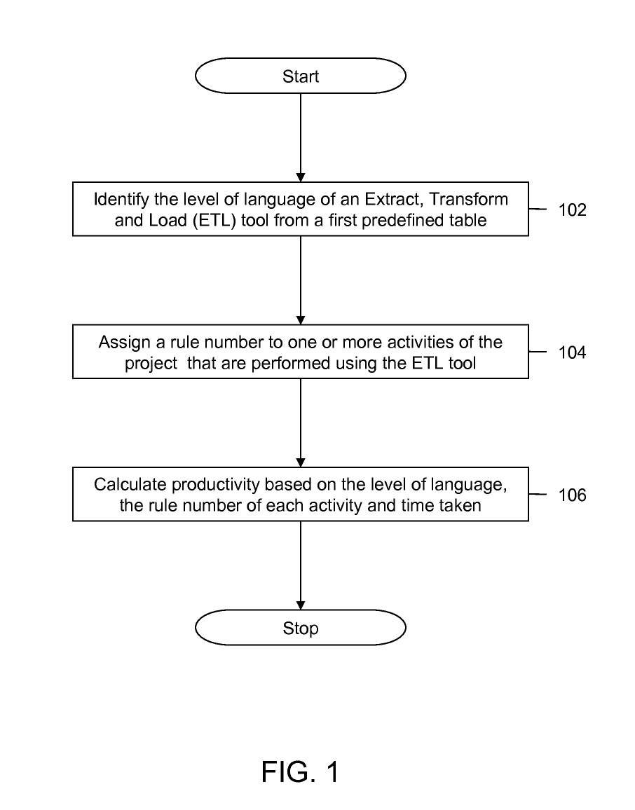

FIG. 1 illustrates a flowchart of a method for estimating the productivity of a team working on a project, in accordance with an embodiment of the invention.

At 102, the level of language of the ETL tool is identified from a first predefined table. In various embodiments of the invention, the level of language represents the complexity level of the language used for the development of the ETL tool. The level of language is identified, based on the generation of language of the ETL tool. The generation of language of an ETL tool represents the generation of the programming language used to build the ETL tool. The generation of language corresponding to each ETL tool is provided in the art. For example, Ab Initio® is built using the fourth-generation language, and the level of language used to build Ab Initio® may be 16, in accordance with the first predefined table. In various embodiments of the invention, the first predefined table represents the relationship between the generation of language and the level of language.

At 104, a rule number is assigned to the one or more activities of a project. In various embodiments of the invention, the rule number of an activity represents the number of rules that should be completed to complete the activity. In various embodiments of the invention, a rule represents a business rule defined by a user. The rule further represents the number of processes of the activity that may be performed and the effort that will be required to perform the processes. For example, if an activity—‘using an input table component for reading data from a database’ includes the processes—mapping the data flow, entering the label and comment, and specifying the read port record format and the effort required to perform the activity is 5 minutes per team member, the number of rules to perform the activity may be one, according to the user.

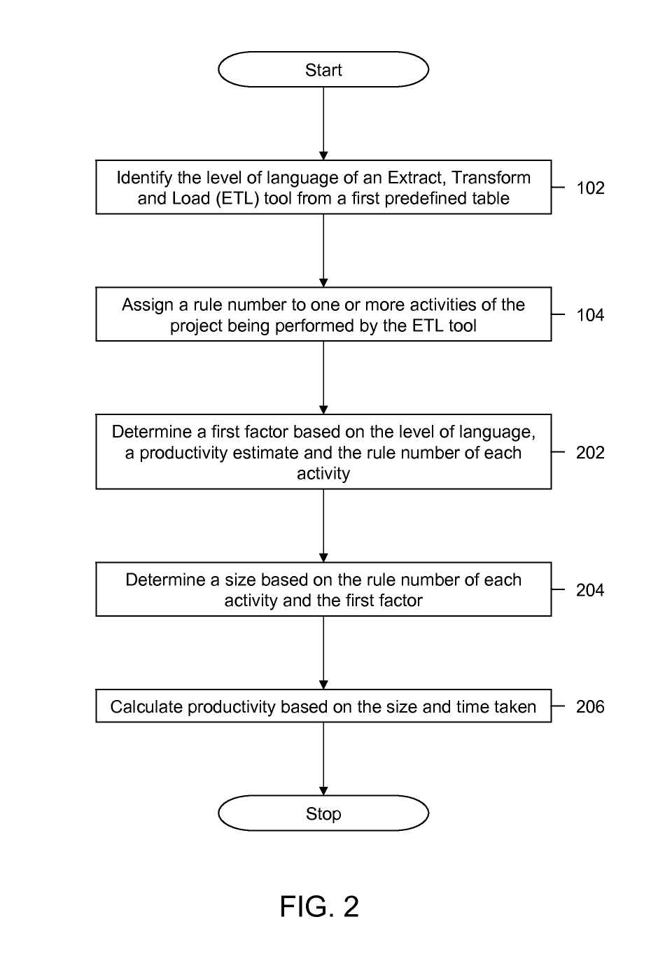

At 106, productivity is calculated for the team working on the project. The productivity of the team is calculated, based on the level of language of the ETL tool, the rule number of the one or more activities being performed on the ETL tool, and the time taken by the team to complete the project. Calculation of productivity is described in detail in conjunction with FIG. 2.

FIG. 2 illustrates a flowchart of a method for estimating the productivity of a team for a project, in accordance with another embodiment of the invention. To describe the method, reference is made to FIG. 1, although it is understood that the method can include fewer or greater number of steps than those illustrated in FIG. 1.

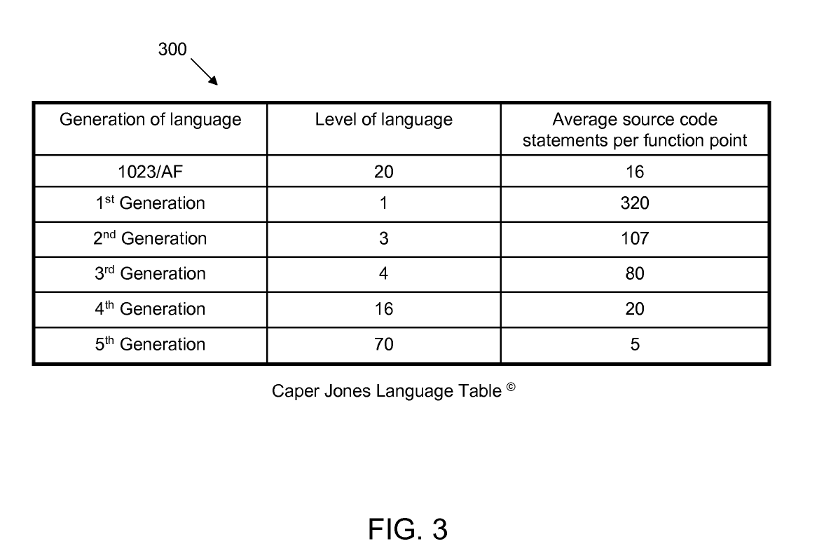

At 102, the level of language of the ETL tool is identified from a first predefined table. In various embodiments of the invention, the level of language represents the complexity level of the language used for the development of the ETL tool. The level of language is identified based on the generation of language of the ETL tool. The generation of language corresponding to each ETL tool is provided in the art. In an embodiment of the invention, the first predefined table is a Caper Jones Language Table©, which has already been provided in the art. The Caper Jones Language Table© is further described in detail in conjunction with FIG. 3.

At 104, a rule number is assigned to the one or more activities of the project. In various embodiments of the invention, the rule number of an activity represents the number of rules that need to be completed to finish the activity. The rule number of an activity is assigned, based on one or more processes that are executed to perform the activity.

In an embodiment of the invention, the rule number is assigned to each activity, based on the complexity level of the activity. In an embodiment of the invention, activities may be classified into various complexity levels. For example, the activities are classified into three complexity levels, namely, simple, medium and complex. In an embodiment of the invention, the complexity level of an activity is determined based on the complexity of the one or more processes being executed to perform the activity.

For a particular complexity level, the rule number may be a value assigned from a predefined range, in accordance with an embodiment of the invention. For example, the rule number of an activity with a simple complexity level is assigned a value between one and five, the rule number of an activity with a medium complexity level is a value between six and nine, and so forth. Further, the rule number of the activity can vary, depending on the scenario. For example, the rule number of the activity—‘changing the record format’ can be two when the number of variables where changes affected are 10, and the rule number can be four when the number of variables where changes affected are 20.

After each activity of the one or more activities has been assigned a rule number, an activity-to-rule number table is developed by the user. In various embodiments of the invention, the activity-to-rule number table includes the one or more activities and the rule number corresponding to each activity. The activity-to-rule number table includes a column for the rule number corresponding to each activity. The activity-to-rule number table is used to determine the rule number that is expected to be completed by a team member. Further, the rule number that is expected to be completed by the team member is used for the calculation of productivity.

In various embodiments of the invention, the rule number is assigned by a user. Examples of the user include a software developer, a team member of the project, and so forth.

At 202, a first factor is determined for the calculation of productivity. In an embodiment of the invention, the first factor is a factor for the workforce approximation of the team.

In an embodiment of the invention, the first factor for a team member is determined based on the level of language determined at 102, the rule number of the one or more activities, as determined at 104, and a productivity estimate.

The level of language determined at 102 is used to identify a ratio of average source code statements to function points, from the first predefined table. The ratio is used to determine the first factor. For example, if the level of language is one, the ratio may be 320, and if the level of language is three, the ratio may be 107, and so forth.

The rule number of the one or more activities determined at 104 is used to determine a number of rules that may be completed by a team member of a particular level of expertise. For example, the number of rules that may be completed by a team member with a basic level of expertise is 1800 per month, and the number of rules that may be completed by a team member with an advanced level of expertise is 2200 per month. In an embodiment of the invention, the number of rules that may be completed by the team member is identified from the activity-to-rule mapping table, which is described in detail in FIG. 1.

The productivity estimate used to determine the first factor represents the number of function points a team member is expected to complete in one month. Typically, the productivity estimate is assigned by the user. The productivity estimate is expressed in terms of function points per team member per month, i.e., the number of function points a team member should complete in a month. The productivity estimate is determined based on an average level of expertise of the team and a productivity range. For example, if the average level of expertise is medium and the productivity range is 15 to 30, the productivity estimate may be 24 function points per team member per month.

The average level of expertise of the team is determined by the user based on the level of expertise of the one or more team members. For example, the average level of expertise is medium when more than half of the team members have a medium level of expertise.

The productivity range represents a range of function points a team member is expected to complete over a predefined time period. In an embodiment of the invention, the predefined time period is one month. In an embodiment of the invention, the productivity range is identified from a second predefined table, which represents the relationship between the level of language and the productivity range.

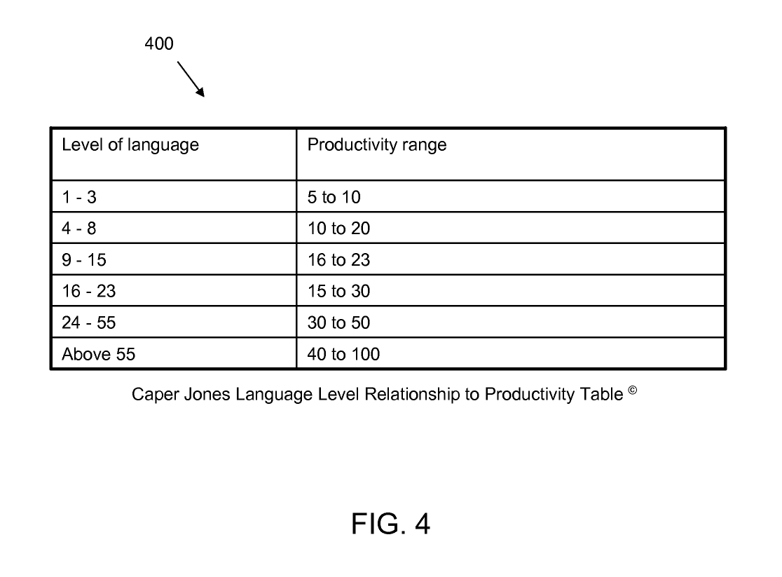

In an embodiment of the invention, the second predefined table is a Caper Jones language level relationship to productivity table© that is already provided in the art. The Caper Jones language level relationship to productivity table© is further described in detail in conjunction with FIG. 4.

The determination of the first factor has been described in the subsequent paragraphs with the help of mathematical equations.

The first factor for a team member of a particular level of expertise is determined on the basis of the productivity estimate assigned by the user, the ratio of average source code statements to function points identified from the first predefined table, based on the level of language, and the rule number a team member of a particular level of expertise is expected to complete, as identified from the activity-to-rule number table. Further, in accordance with an embodiment, the first factor for the team member is described using the following equation:

F=(P×R)÷RN (1)

where, F represents the first factor for the team member, P represents the productivity estimate assigned by the user, R represents the ratio of average source code statements to function points identified from the first predefined table, based on the level of language, and RN represents the rule number a team member of a particular level of expertise is expected to complete, as identified from the activity-to-rule number table.

For example, if F is determined for a team member of an advanced level of expertise, and P is 22, R is 20 and RN is 2000, the first factor is 0.22, in accordance with equation (1).

The first factor for team members with any level of expertise is calculated similarly. For example, if the team member has a medium level of expertise, the first factor may be 0.24, and if the team member has a basic level of expertise, the first factor may be 0.29.

In an embodiment of the invention, the first factor for the entire team is calculated based on the level of expertise of each of the one or more team members. For example, if the percentage of team members with a medium level of expertise is high, the first factor may be 0.25.

At 204, a size of the project is determined for the calculation of productivity. In an embodiment of the invention, the size is determined based on the first factor for the entire team, as calculated at 202, and the rule number of the one or more activities, as determined at 104. In various embodiments of the invention, the size is expressed in function points.

The determination of the size of the project has been described in the subsequent paragraphs with the help of mathematical equations.

The size of the project is determined on the basis of the total rule number that is expected to be completed by the team, and is calculated based on RN and the level of expertise of each team member. Further, the size of the project may be determined using the following equation:

S=(TRN÷R)×FT (2)

where, S represents the size of the project, TRN represents the total rule number that is expected to be completed by the team, and is calculated based on RN and the level of expertise of each team member, R represents the ratio of the source code statements to function points, as identified from the first predefined table, and FT represents the first factor for the entire team, as calculated at 202. For example, if TRN is 2000, R is 20 and FT is 0.25, the size may be 25 function points, in accordance with equation (2).

At 206, the productivity of the team is calculated based on the size and the time taken by the team to complete the project. In an embodiment of the invention, the time taken is expressed in person months. For example, the time taken by the team is four person months when the team comprising of two people takes two months to complete a project.

The calculation of productivity has been described in the subsequent paragraphs with the help of mathematical equations.

The productivity of the team is calculated on the basis of the size of the project, determined at 204, and the time taken by the team to complete the project. Further, the productivity may be calculated using the following equation:

Prod=S÷T (3)

where, Prod represents the productivity of the team, S represents the size of the project, as calculated at 204, and T represents the time taken by the team to complete the project in person months. For example, if S is 25 function points and T is two person months, the productivity, in accordance with equation (3), is 12.5 function points per team member per month. This can be compared with the number of function points the team member was expected to complete, thereby getting an idea of the performance of the team in the project.

FIG. 3 illustrates a section of a Caper Jones Language Table© 300 used to estimate the productivity of a team, in accordance with an embodiment of the invention.

Caper Jones Language Table© 300 represents the approximate number of source code statements to a single function point for various common programming languages. The approximate number of source code statements to a single function point is determined based on a function point estimation technique.

Caper Jones Language Table© 300 includes the generation of language of various programming languages. An ETL tool is developed from the programming language of a particular generation. For example, Ab Initio® is developed from a fourth-generation language. In various embodiments of the invention, the generation of language is used to identify the level of language.

Caper Jones Language Table© 300 further includes the level of language for each generation of language. The level of language represents the complexity level of the language. In various embodiments of the invention, the level of language is used to calculate productivity. For example, as illustrated in FIG. 3, if the generation of language is one, the level of language is one, if the generation of language is two, the level of language is three, and if the generation of language is four, the level of language is 16, and so forth.

Caper Jones Language Table© 300 also includes the ratio of the average source code statements to function points for each level of language. For example, the ratio of average source code statements to function points of the first-generation language is 320, and the second-generation language is 107, and so forth. In various embodiments of the invention, the ratio of average source code statements to function points is used to calculate the first factor and the size of the project.

FIG. 4 illustrates a section of a Caper Jones language level relationship to productivity table© 400 used to estimate the productivity of a team, in accordance with an embodiment of the invention; and

Caper Jones language level relationship to productivity table© 400 represents the variation of productivity with the level of language.

Caper Jones language level relationship to productivity table© 400 includes a column for a range of the level of language. For example, the range may be from 1 to 3, 4 to 8, and 9 to 15, and so forth.

Caper Jones language level relationship to productivity table© 400 further includes a column for productivity range, which corresponds to the range of the level of language. In an embodiment of the invention, the productivity range represents the number of function points that should be completed by a team member in a period of one month. For example, as illustrated in FIG. 4, if the level of language varies from one to three, the productivity range is five to ten.

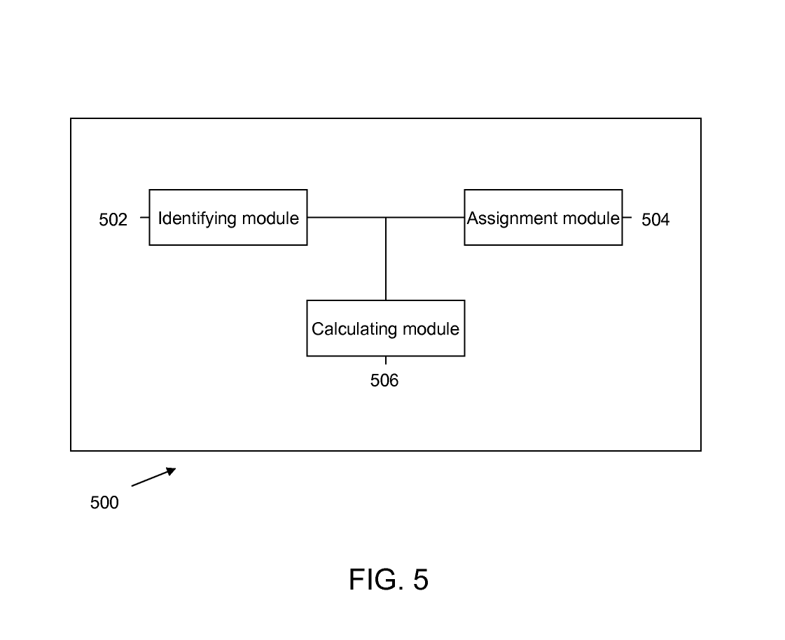

FIG. 5 is a block diagram of a system 500 to estimate the productivity of a team, in accordance with an embodiment of the invention. To describe system 500, reference will be made to FIGS. 2, 3 and 4, although it is understood that system 500 can be implemented with reference to any other suitable embodiment of the invention. System 500 includes an identification module 502, an assignment module 504, and a calculating module 506.

Identification module 502 identifies the level of language of the ETL tool, based on the generation of language of the ETL tool. Assignment module 504 assigns a rule number to each of the one or more activities being performed by the ETL tool. Calculating module 506 calculates the productivity, based on the level of language identified by identification module 502, the rule number for each activity assigned by assignment module 504, and the time taken by the team to complete the one or more activities.

Identification module 502 is configured to identify the level of language of the ETL tool from a first predefined table, based on the generation of language of the ETL tool. The first predefined table represents the relationship between the generation of language and the level of language. In an embodiment of the invention, the first predefined table is the Caper Jones Language Table© which is described in detail in conjunction with FIG. 3. The identification of the level of language is described in detail in conjunction with the description of 102 of FIG. 1 and FIG. 2. In an embodiment of the invention, identification module 502 identifies a ratio of source code statements to function points from the first predefined table, based on the level of language of the ETL tool. In an embodiment of the invention, identification module 502 identifies a productivity range from the second predefined table, based on the level of language of the ETL tool. In an embodiment of the invention, the second predefined table is the Caper Jones language level relationship to productivity table©, which is described in detail in conjunction with FIG. 4. The identification of the ratio and the productivity range is described in detail in conjunction with the description of 202 of FIG. 2.

Assignment module 504 is configured to assign a rule number to each of the one or more activities performed by the ETL tool. The rule number for each activity is assigned, based on one or more processes that are executed to perform the activity. The assignment of the rule number to each of the one or more activities is described in detail in conjunction with the description of FIG. 2. In an embodiment of the invention, assignment module 504 maps the activities and the rule numbers on to an activity-to-rule number table. The activity-to-rule number table is described in detail in conjunction with the description of 104 of FIG. 2.

Calculating module 506 is configured to calculate the productivity of the team, based on the level of language, the rule number of each activity, and the time taken to complete the project. The calculation of productivity includes determining a first factor, which represents a factor for the workforce approximation of the team. In an embodiment of the invention, the first factor is determined, based on the level of language, the rule number of the one or more activities, and a productivity estimate. The productivity estimate is determined, based on an average level of expertise and a productivity range. In an embodiment of the invention, calculating module 506 determines the first factor based on equation (1). The determination of the first factor is described in detail in conjunction with the description of 202 of FIG. 2.

Calculating module 506 further determines a size of the project to calculate productivity. In an embodiment of the invention, the size is calculated, based on the first factor of the entire team and the rule number of the one or more activities. In another embodiment of the invention, calculating module 506 determines the size based on equation (2). The determination of the size of the project is described in detail in conjunction with the description of 204 of FIG. 2.

Calculating module 506 calculates the productivity, based on the size of the project and the time taken by the team to complete the project. In an embodiment of the invention, calculating module 506 calculates the productivity of the team based on equation (3). The calculation of productivity is described in detail in conjunction with the description of 206 of FIG. 2.

The method and system described above include identifying the level of language from a first predefined table, based on the generation of language of the ETL tool. Further, the first predefined table is the Caper Jones Language Table© in various embodiments of the invention. Furthermore, the productivity is estimated using the Caper Jones Language Table© and simple equations. In addition, the level of expertise of the team members is used to estimate productivity. As the method involves estimation of productivity based on the level of language and the level of expertise of the team members, it provides a more accurate and efficient estimate of productivity. The estimate of productivity is quantified and expressed in function points per staff months. Therefore, the estimated productivity can be easily compared with the expected productivity, as indicated in the first predefined table for the team.

The system for estimating the productivity of a team for a project or any of its components may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and the Internet. The computer further comprises a microprocessor. The microprocessor is connected to a communication bus. The computer also includes a memory. The memory may include Random Access Memory (RAM) and Read Only Memory (ROM). The computer system further comprises a storage device. The storage device can be a hard disk drive or a removable storage drive such as a floppy disk drive, optical disk drive, etc. The storage device can also be other similar means of loading computer programs or other instructions to the computer system. The computer system also includes a communication unit. The communication unit enables the computer to connect to other databases and the Internet through an I/O interface. The communication unit enables transfer to and reception of data from other databases. The communication unit may include a modem, an Ethernet card, or any similar device which enables the computer system to connect to databases and networks such as LAN, MAN, WAN and the Internet. The computer system facilitates inputs from a user through an input device which is accessible to the system through an I/O interface.

The computer system executes a set of instructions that is stored in one or more storage elements, to process input data. The storage elements may also hold data or other information, as desired. The storage element may be in the form of an information source or a physical memory element present in the processing machine.

The set of instructions may include various commands that instruct the processing machine to perform specific tasks such as the steps that constitute the method of the present invention. The set of instructions may be in the form of a software program. Further, the software may be in the form of a collection of separate programs, a program module with a large program, or a portion of a program module, as described in the present invention. The software may also include modular programming in the form of object-oriented programming. The processing of input data by the processing machine may be in response to user commands, results of previous processing or a request made by another processing machine.

While the preferred embodiments of the invention have been illustrated and described, it will be clear that the invention is not only limited to these embodiments. Numerous modifications, changes, variations, substitutions and equivalents will be apparent to those skilled in the art without departing from the spirit and scope of the invention, as described in the claims.

What is claimed is:

1. A method for estimating productivity of a team working on a project, the team comprising one or more team members, the project comprising one or more activities, the one or more activities being performed using an Extract, Transform and Load (ETL) tool, the method comprising:
a. identifying the level of language of the ETL tool, the level of language being identified from a first predefined table based on the generation of language of the ETL tool, wherein the first predefined table represents a relationship between the generation of language and the level of language;
b. assigning a rule number to each of the one or more activities, wherein the rule number for each activity is assigned based on one or more processes that are executed for performing the activity; and
c. calculating the productivity of the team based on the level of language, the rule number of each activity, and the time taken by the team for completing the project.

2. The method of claim 1, wherein the first predefined table is a Caper Jones Language Table.

3. The method of claim 1 further comprises determining a first factor for calculating the productivity, the first factor being determined based on the level of language, the rule number of each activity, a productivity estimate for the team and a level of expertise of each of the one or more team members.

4. The method of claim 3 further comprising determining the productivity estimate for the team for determining the first factor, wherein the productivity estimate for the team is determined based on an average level of expertise of the team and a productivity range, the productivity range being identified from a second predefined table based on the level of language, wherein the second predefined table represents a relationship between the level of language and the productivity range.

5. The method of claim 4, wherein the second predefined table is a Caper Jones language level relationship to productivity table.

6. The method of claim 3 further comprises identifying a ratio of average source code statements to function points for determining the first factor, the ratio being identified from the first predefined table based on the level of language, wherein the first predefined table further represents the relationship between the level of language and the ratio.

7. The method of claim 3 further comprises determining a size of the project for the calculation of productivity, the size being determined based on the rule number of each activity and the first factor.

8. The method of claim 7, wherein the productivity is calculated based on the size and the time taken for completing the project.

9. The method of claim 1, wherein the assignment of rule number to each activity is further based on a complexity level of the activity.

10. A system for estimating productivity of a team working on a project, the team comprising one or more team members, the project comprising one or more activities, the one or more activities being performed using an Extract, Transform and Load (ETL) tool, the system comprising:
a. an identification module configured for identifying the level of language of the ETL tool, the level of language being identified from a first predefined table based on the generation of language of the ETL tool, wherein the first predefined table represents a relationship between the generation of language and the level of language;
b. an assignment module configured for assigning a rule number to each of the one or more activities, wherein the rule number for each activity is assigned based on one or more processes that are executed for performing the activity; and
c. a calculating module configured for calculating the productivity of the team based on the level of language, the rule number of each activity, and the time taken by the team for completing the project.

11. The system of claim 10, wherein the first predefined table is a Caper Jones Language Table.

12. The system of claim 10, wherein the calculating module is configured for determining a first factor for calculating the productivity, the first factor being determined based on the level of language, the rule number of each activity, a productivity estimate for the team and a level of expertise of each of the one or more team members.

13. The system of claim 12, wherein the calculating module is further configured for determining the productivity estimate for the team based on an average level of expertise and a productivity range, the productivity range being identified from a second predefined table based on the level of language, wherein the second predefined table represents a relationship between the level of language and the productivity range.

14. The system of claim 13, wherein the second predefined table is a Caper Jones language level relationship to productivity table.

15. The system of claim 12, wherein the identification module is configured for identifying a ratio of average source code statements to function points, the ratio being used for calculating the first factor, the ratio being identified from the first predefined table based on the level of language, wherein the first predefined table further represents the relationship between the level of language and the ratio.

16. The system of claim 12, wherein the calculating module is configured for determining a size of the project for calculating the productivity, wherein the size is determined based on the rule number of each activity and the first factor.

17. The system of claim 16, wherein the calculating module calculates the productivity based on the size and the time taken for completing the project.

18. A computer program product for use with a computer, the computer program product comprising a computer usable medium having a computer readable program code embodied therein for estimating productivity of a team working on a project, the team comprising one or more team members, the project comprising one or more activities, the one or more activities being performed using an Extract, Transform and Load (ETL) tool, the computer readable program code performing:
a. identifying the level of language of the ETL tool, the level of language being identified from a first predefined table based on the generation of language of the ETL tool, wherein the first predefined table represents a relationship between the generation of language and the level of language;
b. assigning a rule number to each of the one or more activities, wherein the rule number for each activity is assigned based on one or more processes that are executed for performing the activity; and
c. calculating the productivity of the team based on the level of language, the rule number of each activity, and the time taken by the team for completing the project.

19. The computer program product of claim 18, wherein the first predefined table is a Caper Jones Language Table.

20. The computer program product of claim 18, wherein the computer readable program code further performs determining a first factor for calculating the productivity, the first factor being determined based on the level of language, the rule number of each activity, a productivity estimate for the team and a level of expertise of each of the one or more team members.

21. The computer program product of claim 20, wherein the computer readable program code further performs determining the productivity estimate for the team for determining the first factor, the productivity estimate for the team being determined based on an average level of expertise of the team and a productivity range, the productivity range being identified from a second predefined table based on the level of language, wherein the second predefined table represents a relationship between the level of language and the productivity range.

22. The computer program product of claim 21, wherein the second predefined table is a Caper Jones language level relationship to productivity table.

23. The computer program product of claim 20, wherein the computer readable program code further performs identifying a ratio of average source code statements to function points for determining the first factor, the ratio being identified from the first predefined table based on the level of language, wherein the first predefined table further represents the relationship between the level of language and the ratio.

24. The computer program product of claim 20, wherein the computer readable program code further performs determining a size of the project for calculating the productivity, wherein the size is determined based on the rule number of each activity and the first factor.

25. The computer program product of claim 24, wherein the computer readable program code calculates the productivity based on the size and the time taken for completing the project.
